(19) United States
(12) Patent Application Publication
(10) Pub. No.: US 2016/0326279 A1
(43) Pub. Date: Nov. 10, 2016

(54) SUPRAMOLECULAR STRUCTURE OF ACRYLIC ACID, AND Li-ION BATTERY USING SAME

(71) Applicant: HITACHI, LTD., Tokyo (JP)

(72) Inventor: Shirun HO, Tokyo (JP)

(21) Appl. No.: 15/110,107

(22) PCT Filed: Feb. 6, 2014
(86) PCT No.: PCT/JP2014/052774

§ 371 Date: Jul. 7, 2016

(51) Int. Cl. C08F 20/06; H01M 10/0525; H01M 4/62; C08G 83/00

(52) U.S. Cl. CPC C08F 20/06; C08G 83/008; H01M 10/0525; H01M 4/622; H01M 2004/027

(57) ABSTRACT

As a method for improving the service life of a Li-ion battery, a supramolecular structure of acrylic acid which is a polymer formed by aggregating m number (an aggregation degree of m) of single chains each including n number (a polymerization degree of n) of acrylic acid monomers connected to each other, and has a constricted (narrowing) channel structure in which the single chains are arranged in a circle on the xy plane, a main chain is oriented along the direction of a central axis in the z direction, and a carboxyl group in a side chain is oriented along a direction perpendicular to the central axis in the z direction is used. As a result of an interaction between this constricted channel structure and an organic solvent molecule, the organic solvent molecule is captured inside the constricted channel structure, and the diffusion of the organic solvent molecule is inhibited.

### TECHNICAL FIELD

The present invention relates to a supramolecular structure of acrylic acid which has a function of capturing a nanoscale small molecule and is used for an electrode film of a Li-ion battery or for drug delivery.

### BACKGROUND ART

In accordance with the expansion of the use of portable devices and the increase in the mass production volume thereof, a thin and lightweight Li-ion battery has become widely used. The future application thereof to electrical cars, distributed and stationary-type leveling power supplies, and industrial-use batteries has been expected, and the further expansion thereof in the market is prospected. In addition, as a next-generation medical therapy, in a drug delivery system, after a supramolecular structure that captures a drug molecule is diffused in the body, the supramolecular structure is collapsed in a specific site, and the drug molecule is allowed to act only in the site, and thus, high drug efficacy and few side effects by the administration of a small dose of the drug are expected.

With respect to the charge-discharge cycle dependency of the capacity retention and the storage time dependency of the capacity retention in a Li-ion battery, the irreversible capacity experimentally tends to increase in proportion to the charge-discharge cycle number and the ½ power of the storage time. Because of the occurrence of this irreversible capacity, the capacity of the battery is decreased, and the service life thereof is deteriorated.

With reference to FIG. 1, the charge-discharge cycle characteristics of the capacity retention will be described. A Li-ion battery is constituted by a positive electrode, a negative electrode, a separator, and an electrolyte, however, in FIG. 1, an interfacial region between a negative electrode material and the electrolyte are shown. As the negative electrode, graphite of natural black lead, artificial black lead, or the like is used, and as the positive electrode, Co, Ni, a Mn alloy, or the like is used. As the electrolyte, an organic solvent such as EC (ethylene carbonate) or DEC (diethylene carbonate) is used. When a Li salt such as LiPF₆ is mixed in a mixed liquid of such an organic solvent, Li and PF₆ are dissociated, whereby an electrolyte in which a Li ion and a PF₆ anion are dissolved is formed. When a voltage is applied thereto, the Li ion conducts between the positive electrode and the negative electrode through the electrolyte.

In the charging process of the Li-ion battery, a negative potential is applied to the positive electrode and a positive potential is applied to the negative electrode. First, a Li atom accumulated in an active site of a positive electrode material is discharged as a Li ion into the electrolyte. At this time, an electron is discharged to the positive electrode material, and the electron flows in an external circuit. The discharged Li ion conducts in the electrolyte and passes through the separator which is porous and has a pore. Further, the Li ion enters the negative electrode material after conducting in the electrolyte. An electron is transferred from the negative electrode material and accumulated as a Li atom in an active site of the negative electrode material. Here, the active site of the negative electrode material is LiC₆ in the case of graphite and is Li_{4.4}Si in the case of a Si-based alloy.

On the other hand, in the discharging process, the positive and the negative electrodes are connected to a load resistance. Alternatively, a positive potential is applied to the positive electrode and a negative potential is applied to the negative electrode. The Li atom accumulated in the active site of the negative electrode material is discharged as a Li ion into the electrolyte. At this time, an electron is discharged to the negative electrode material, and the electron flows in the external circuit. The discharged Li ion conducts in the electrolyte and passes through the separator which is porous and has a pore. Further, the Li ion enters the positive electrode material after conducting in the electrolyte. An electron is transferred from the positive electrode and accumulated as a Li atom in the active site of the positive electrode material. By repeating this charge-discharge operation, it can play a role of a storage battery.

The theoretical capacity in this charge-discharge operation is 372 mAh/g in the case of graphite (LiC₆) and is 4200 mAh/g in the case of a Si-based alloy (Li_{4.4}Si). In order to reduce the charging frequency for a smartphone or an electrical car, further development of a high-capacity negative electrode material is sought. Further, the potential at which a Li ion enters the graphite negative electrode is higher than the standard electrode potential of Li⁺/Li (−3.05 V) by 0.05 V, and the potential at which a Li ion enters the Si-based alloy negative electrode is higher than the standard electrode potential of Li⁺/Li by 0.4 V. The Li-ion battery has a wide charge-discharge potential window and has a high energy density, and therefore is promising as a next-generation storage battery.

However, at the time of charging and discharging a Li ion, due to the expansion and contraction of the volume of the particles of the negative electrode material, collapse occurs to cause deterioration of the capacity, and therefore, an object is to achieve both increase in the capacity and extension of the service life. In the service life of the Li-ion battery, a passivation film to be formed at the interface between the negative electrode material and the electrolyte plays an important role. At a potential which is higher than the standard electrode potential of Li⁺/Li (−3.05 V) by about 1 V, the organic solvent molecule of the electrolyte diffuses in the negative electrode and is reductively decomposed on the edge surface of graphite or a Si-based alloy. The resulting reduced material and a Li ion react with each other to form a film of an organic compound or an inorganic compound as a passivation film. At this time, a Li ion is consumed irreversibly, and therefore, an irreversible capacity induces to decrease the battery capacity. On the other hand, the film of an organic compound has an ether chain (CH₂—CH₂—O)— of a strong polar group, and a Li ion can hop over the polar group and permeate the film with low resistivity. Further, the films of an organic compound and an inorganic compound suppress the permeation of an organic solvent molecule, and therefore suppress the reductive decomposition on the edge surface of graphite or a Si-based alloy. In this manner, a passivation film which allows a Li ion to permeate and blocks the diffusion of an organic solvent molecule is spontaneously formed, and controls the service life of a Li-ion battery.

In order to improve the service life of a Li-ion battery, there is a method in which VC (vinylene carbonate) or the like is added to an organic solvent molecule to change the composition of a passivation film to be formed by reductive decomposition, thereby suppressing the deterioration of the capacity. Further, conventionally, as a binder for a negative electrode material, polyvinylidene difluoride (PVDF) has been used, however, NPL 1 reports that when an acrylic acid polymer is used as a binder for a high-capacity negative electrode material, the deterioration of the capacity is suppressed.

### CITATION LIST

### Non Patent Literature

NPL 1: S. Komaba, “Study on Polymer Binders for High-Capacity SiO Negative Electrode of Li-Ion Batteries”, J. Phys. Chem. C, 115, pp. 13487-13495, 2011

### SUMMARY OF INVENTION

### Technical Problem

A physical mechanism for suppressing such deterioration of the capacity in a Li-ion battery has not been known, and there are many unclear points, and therefore, an object is to further improve the service life. Here, the object to improve the service life is achieved by forming a film with selective molecular permeability which inhibits the diffusion of an organic solvent molecule using an acrylic acid oligomer as a binder for a high-capacity negative electrode material of a Li-ion battery, thereby suppressing the deterioration of the capacity in place of a passivation film.

An object of the present invention is to provide a supramolecular structure of acrylic acid which has a function of capturing a nanoscale small molecule and can be used for an electrode film of a Li-ion battery or for drug delivery.

### Solution to Problem

In order to achieve the above object, the invention adopts the configuration described in the claims.

The invention includes a plurality of means for solving the above-mentioned problem, and one example thereof is a supramolecular structure of acrylic acid which is a polymer formed by aggregating m number (an aggregation degree of m) of single chains each including n number (a polymerization degree of n) of acrylic acid monomers connected to each other, and has a constricted channel structure in which the single chains are arranged in a circle on the xy plane, a main chain is oriented along the direction of a central axis in the z direction, and a carboxyl group in a side chain is oriented along a direction perpendicular to the central axis in the z direction.

### Advantageous Effects of Invention

According to the invention, as a result of an interaction between the constricted (narrowing) channel structure in the polymer of acrylic acid having a polymerization degree of n and an aggregation degree of m and an organic solvent molecule, the organic solvent molecule is captured inside the constricted channel structure, and the diffusion of the organic solvent molecule can be inhibited.

When this supramolecular structure of acrylic acid is used as a binder for a negative electrode of a Li-ion battery, the reductive decomposition on the edge surface of graphite or a Si-based alloy is suppressed, and the occurrence of irreversible capacity is reduced, and thus, the service life of the Li-ion battery can be improved.

### BRIEF DESCRIPTION OF DRAWINGS

FIG. 1 is a view showing an interfacial region between a negative electrode material and an electrolyte in a Li-ion battery of the invention.

FIG. 2A is a view showing a constricted (narrowing) channel structure of an acrylic acid oligomer in a supramolecular structure of acrylic acid (polymerization degree: 8, aggregation degree: 10, z-axis direction) of a first embodiment of the invention.

FIG. 2B is a view showing the constricted channel structure of an acrylic acid oligomer in the supramolecular structure of acrylic acid (polymerization degree: 8, aggregation degree: 10, yz-plane direction) of the first embodiment of the invention.

FIG. 3 is a view showing the molecular formula of an acrylic acid polymer.

FIG. 4 is a view showing the molecular structure of an acrylic acid oligomer (polymerization degree: 8) constituting the supramolecular structure of acrylic acid of a first embodiment of the invention.

FIG. 5 is a view showing the dependency on the arrangement structure (polymerization degree: 8, aggregation degree: 10) of an aggregation energy in the polymer of an acrylic acid oligomer in the supramolecular structure of acrylic acid of the first embodiment of the invention.

FIG. 6 is a view showing the dependency on the polymer structure (polymerization degree: 2, 4, 6, 8, 10, 12, 14, or 16, aggregation degree: 10 or 16) of an acrylic acid oligomer of the minimum aggregation energy in the supramolecular structure of acrylic acid of the first embodiment of the invention.

FIG. 7A is a view showing a constricted channel structure of an acrylic acid oligomer in a supramolecular structure of acrylic acid (polymerization degree: 16, aggregation degree: 4, z-axis direction) of the first embodiment of the invention.

FIG. 7B is a view showing the constricted channel structure of an acrylic acid′ oligomer in the supramolecular structure of acrylic acid (polymerization degree: 16, aggregation degree: 4, yz-plane direction) of the first embodiment of the invention.

FIG. 8A is a view showing an EC molecule captured in a constricted channel structure of an acrylic acid oligomer in a supramolecular structure of acrylic acid (polymerization degree: 8, aggregation degree: 10, z-axis direction) of a second embodiment of the invention.

FIG. 8B is a view showing the EC molecule captured in the constricted channel structure of an acrylic acid oligomer in the supramolecular structure of acrylic acid (polymerization degree: 8, aggregation degree: 10, yz-plane direction) of the second embodiment of the invention.

FIG. 9 is a view showing the dependency on the position in the z direction of an EC molecule of the energy of the interaction between the polymer of an acrylic acid oligomer and the EC molecule in the supramolecular structure of acrylic acid of the second embodiment of the invention.

FIG. 10 is a view showing the structure of an acrylic acid binder using a supramolecular polymer structure of acrylic acid of a third embodiment of the invention.

### DESCRIPTION OF EMBODIMENTS

Hereinafter, embodiments of the invention will be described in detail with reference to the drawings.

Incidentally, in all the drawings for illustrating the embodiments, the same reference numerals are given to the same portions in principle, and the repeated description thereof will be omitted.

### First Embodiment

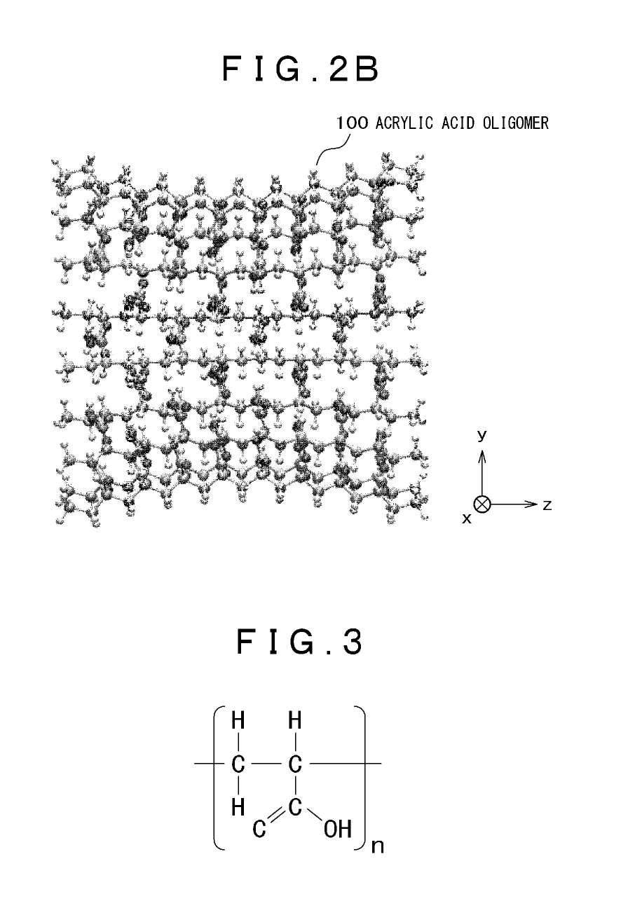

FIGS. 2A and 2B show a constricted channel structure formed using an acrylic acid oligomer in a first embodiment of the invention. Hereinafter, a three-dimensional molecular structure will be described in detail.

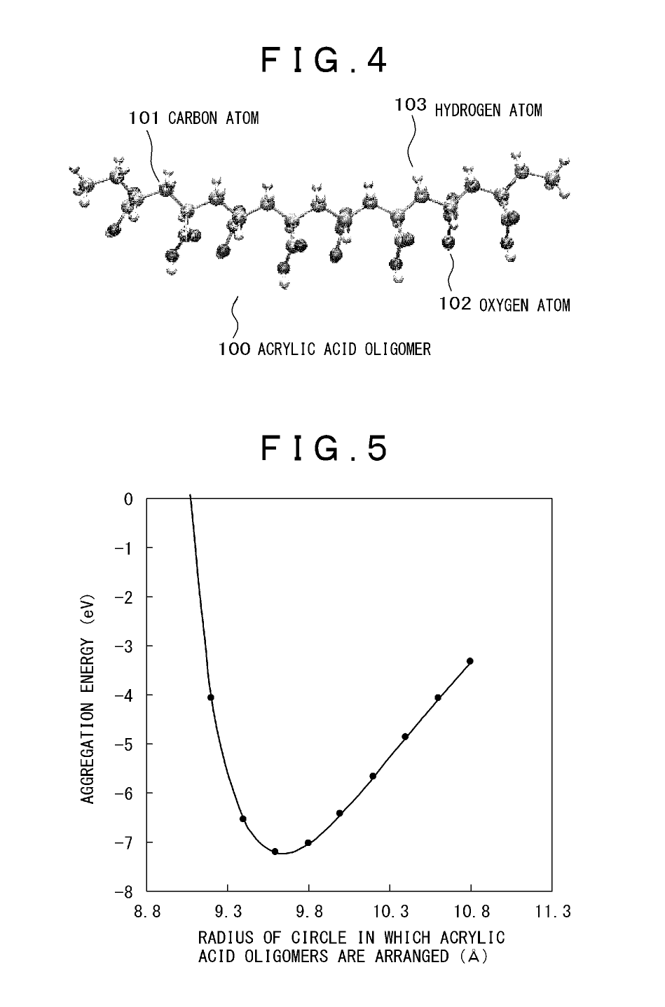

FIG. 3 shows the molecular formula of an acrylic acid polymer. A main chain is composed of a methylene group and a side chain is composed of a carboxyl group, and the polymer has a chemical composition in which monomers are connected to each other in the form of a chain. FIG. 4 shows the molecular structure of an acrylic acid oligomer. In the oligomer, 8 monomers are connected to each other in the form of a chain, and the polymerization degree is 8. Here, the terminal is terminated with a methyl group, and the oligomer is constituted by a carbon atom, an oxygen atom, and a hydrogen atom. The carboxyl group of the monomer at the leftmost end is oriented on the back side of the sheet, and the carboxyl group of the second monomer from the left end is oriented on the front side of the sheet. That is, these two monomers are structures which are mirror symmetric to each other. In this manner, the molecular structure of the acrylic acid oligomer having a polymerization degree of 8 is a structure curved in the form of an arc, in which an acrylic acid monomer structure and a mirror symmetric structure thereof are alternately repeated 4 times.

FIG. 2A shows a polymer structure having an aggregation degree of 10, in which 10 molecules of this acrylic acid oligomer having a polymerization degree of 8 are aggregated. Here, the plane of the sheet is referred to as “xy-plane”, and the direction perpendicular thereto is referred to as “z-axis direction”. The acrylic acid oligomers are arranged in a circle on the xy plane, and the main chain is oriented along the direction of a central axis in the z direction, and the carboxyl group in the side chain is oriented along a direction perpendicular to the central axis in the z direction. As shown in FIG. 2A, a channel structure in the form of a hole is present in a central part when seen from the z-axis direction. Further, as shown in FIG. 2B, a constricted (narrowing) structure is present in a central part when seen from the yz-plane, and therefore, a constricted channel structure is formed.

FIG. 5 is a view showing the dependency of the aggregation energy of a polymer having an aggregation degree of 10 when the radius of a circle in which the acrylic acid oligomers having a polymerization degree of 8 are arranged on the xy-plane is changed. When the radius of the circle is small, due to the van der Waals force between molecules and the Coulomb repulsion energy, the aggregation energy becomes a positive value, and the structure is unstable. When the radius of the circle is increased, the repulsion energy is decreased and the attractive force acts between molecules, and therefore, the aggregation energy is decreased to a negative value, and when the radius of the circle is around 9.6 Å, the minimum energy is realized. Further, when the radius of the circle is increased, the attractive force between molecules is decreased, and therefore, the aggregation energy is increased. In view of this, in the polymer having an aggregation degree of 10 formed by using an acrylic acid oligomer having a polymerization degree of 8, when the radius of the circle is around 9.6 Å, a stable constricted channel structure is formed.

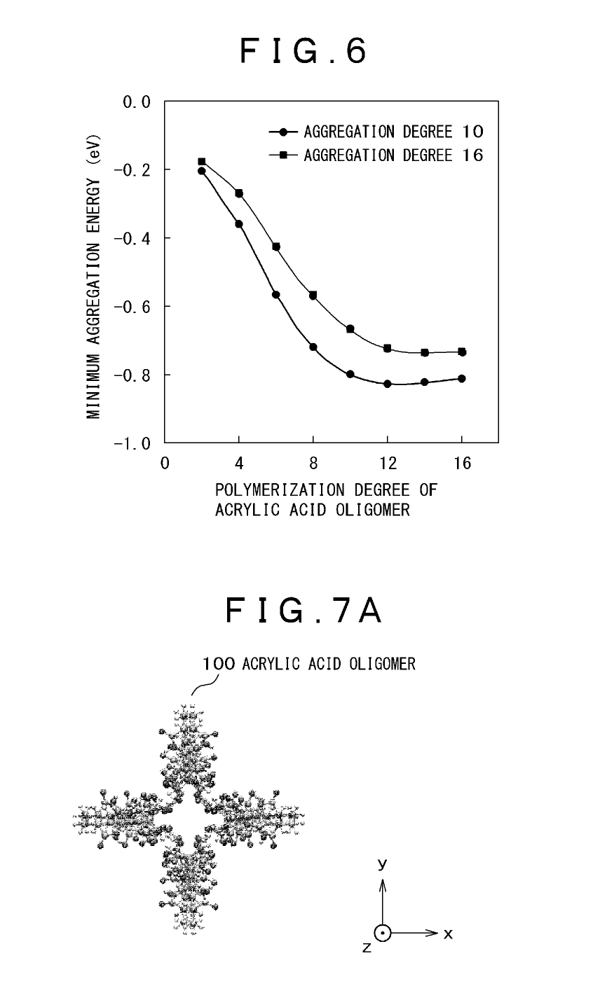

Next, FIG. 6 shows the minimum aggregation energy in a polymer structure having an aggregation degree of m (=10 or 16) formed by using an acrylic acid oligomer having a polymerization degree of n (=2, 4, 6, 8, 10, 12, 14, or 16). In the case of a 10-mer, the minimum aggregation energy is high when the polymerization degree is small, however, as the polymerization degree is increased, the minimum aggregation energy is decreased, and when the polymerization degree is sufficiently increased, the minimum aggregation energy becomes substantially constant. Also in the case of a 16-mer, the minimum aggregation energy is high when the polymerization degree is small, however, as the polymerization degree is increased, the minimum aggregation energy is decreased, and when the polymerization degree is sufficiently increased, the minimum aggregation energy becomes substantially constant. This energy dependency is because the molecular structure of the acrylic acid oligomer is a structure curved in the form of an arc. Therefore, when the polymerization degree of the acrylic acid oligomer is small, the minimum aggregation energy is high, and a difference in the aggregation energy with respect to an acrylic acid oligomer having a different aggregation degree is small. Further, when the polymerization degree of the acrylic acid oligomer is large, the minimum aggregation energy is low, and a change in the aggregation energy with respect to an acrylic acid oligomer having a different polymerization degree is small.

In order to form a polymer structure using an acrylic acid oligomer, it is necessary to sufficiently decrease the polymerization degree of the acrylic acid oligomer so that the acrylic acid oligomer is easy to diffuse. In addition, in order to form a stable polymer structure using an acrylic acid oligomer, it is necessary to sufficiently increase the polymerization degree of the acrylic acid oligomer so that the aggregation energy is decreased. As shown in FIG. 6, it is considered that an acrylic acid oligomer having a polymerization degree of about 10, at which the minimum aggregation energy is decreased and becomes substantially constant, is easy to diffuse, and therefore forms a stable polymer structure.

When an acrylic acid oligomer which has a polymerization degree of less than 10 and is short is used, a difference in the aggregation energy with respect to an acrylic acid oligomer having a different aggregation degree is small, and therefore, a polymer having a different aggregation degree can be intermingled. Further, when an acrylic acid oligomer which has a polymerization degree of less than 10 and is short is used, the short oligomer is easy to diffuse, and therefore, when the constricted channel structure of the polymer is collapsed due to some factors, the short oligomer diffuses, and by re-aggregating the short oligomer, the constricted channel structure can be formed. This indicates that the constricted channel structure has a self-repair or self-healing function.

On the other hand, when an acrylic acid oligomer which has a polymerization degree of more than 10 and is long is used, the change in the aggregation energy with respect to an acrylic acid oligomer having a different polymerization degree is small, and therefore, a stable polymer structure can be formed.

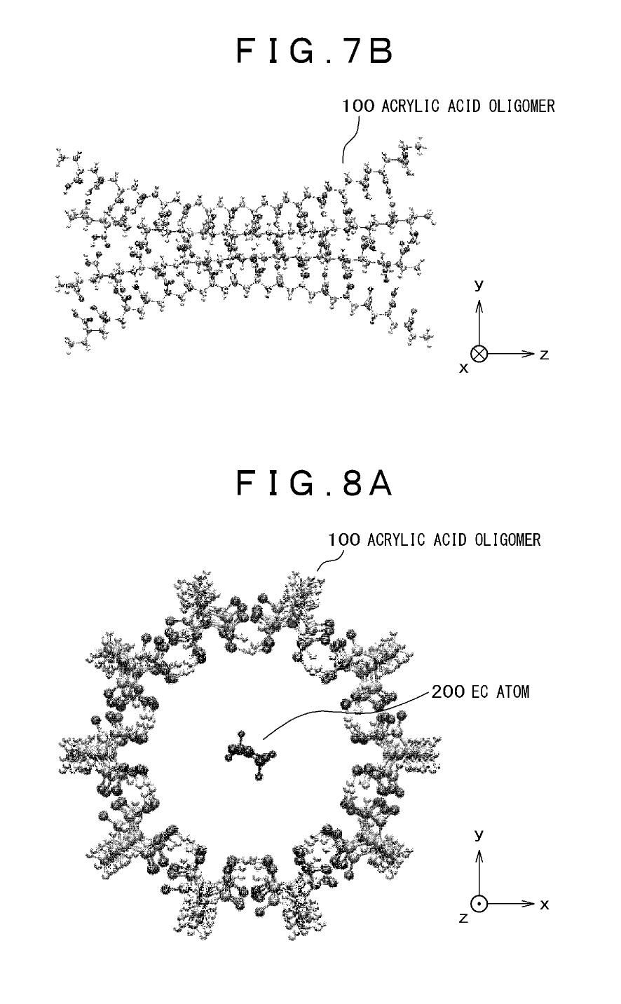

Further, FIGS. 7A and 7B show a constricted channel structure having an aggregation degree of 4 formed by using an acrylic acid oligomer having a polymerization degree of 16. By using a different polymerization degree or a different aggregation degree, the radius of a port of the constricted channel structure and the radius of a constricted portion can be changed.

### Second Embodiment

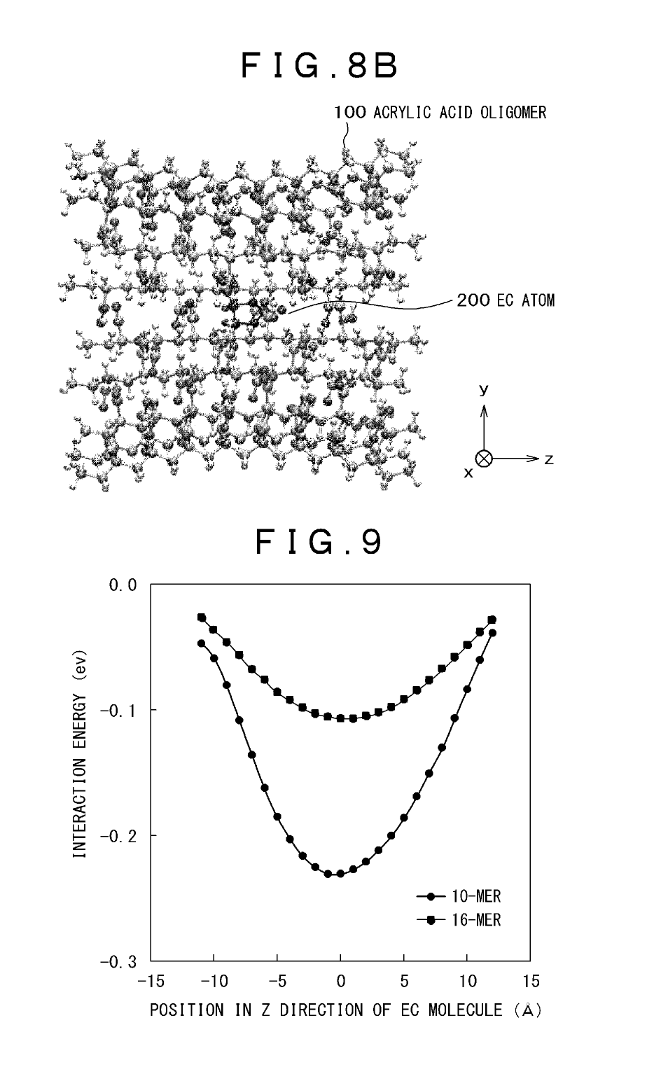

FIGS. 8A and 8B are views showing a structure in which an EC molecule of an organic solvent molecule is captured inside a constricted channel structure formed by using an acrylic acid oligomer having a polymerization degree of 8 and an aggregation degree of 10 in a second embodiment of the invention. As shown in FIG. 8A, the EC molecule is present in a central part of the channel structure in the form of a hole when seen from the z-axis direction. Further, as shown in FIG. 8B, the EC molecule is captured inside the constricted structure in a central part when seen from the yz-plane direction.

FIG. 9 is a view showing the dependency on the position in the z-axis direction of the interaction energy of an EC molecule with respect to the constricted channel structures having an aggregation degree of 10 or 16 formed by using an acrylic acid oligomer having a polymerization degree of 8. In the case of a 10-mer having an aggregation degree of 10, a deep valley of the potential energy is formed in the vicinity of a central part (z=0 Å) of the constricted channel structure. When an EC molecule enters from the port of the constricted channel structure while diffusing, the molecule falls into the deep valley of the potential energy in the central part. The valley of the potential energy is sufficiently deep as compared with 0.026 eV, a thermal energy at room temperature, and therefore, it is difficult for the EC molecule to diffuse and escape from the deep valley of the potential energy in the central part to the outside the constricted channel structure. Therefore, the constricted channel structure formed by using the acrylic acid oligomer has a function of capturing the EC molecule and inhibiting the diffusion thereof.

Further, in the case of a 16-mer having an aggregation degree of 16, a valley of the potential energy is formed in the vicinity of a central part (z=0 Å) of the constricted channel structure in the same manner. When an EC molecule enters from the port of the constricted channel structure while diffusing, the molecule falls into the deep valley of the potential energy formed in the central part. The valley of the potential energy is deeper than 0.026 eV at room temperature but is shallower than that of the constricted channel structure having an aggregation degree of 10. This indicates that when the aggregation degree of the acrylic acid oligomer is changed, the energy of the interaction between the constricted channel structure and the EC molecule is changed.

Therefore, the function of inhibiting the diffusion of a small molecule can be controlled by forming the constricted channel structure in which a polymer having a different aggregation degree or a different polymerization degree is intermingled so as to change the energy of the interaction between the constricted channel structure and the EC molecule, thereby adjusting the action of capturing the small molecule.

When an acrylic acid oligomer which has a polymerization degree of less than 10 and is short is used, a difference in the aggregation energy with respect to an acrylic acid oligomer having a different aggregation degree is small, and therefore, a constricted channel structure having a different aggregation degree can be intermingled. Since such constricted channel structures having a different aggregation degree are intermingled, the energy of the interaction between the constricted channel structure and the EC molecule is changed, thereby adjusting the action of capturing the EC molecule, and thus, the function of inhibiting the diffusion thereof can be controlled.

When an acrylic acid oligomer which has a polymerization degree of more than 10 and is long is used, the change in the aggregation energy with respect to an acrylic acid oligomer having a different polymerization degree is small, and therefore, a stable constricted channel structure can be formed. By fixing the energy of the interaction between the constricted channel structure and the EC molecule, the action of capturing the EC molecule is adjusted, and thus, the function of inhibiting the diffusion thereof can be controlled.

Further, as shown in FIGS. 7A and 7B, a constricted channel structure in which a polymer having a different polymerization degree or a different aggregation degree is intermingled is formed so as to change the radius of a port of the constricted channel structure and the radius of a constricted portion, thereby capturing a small molecule having a different size or changing the number of small molecules to be captured, and thus, the function of inhibiting the diffusion of the small molecule can be controlled.

When an acrylic acid oligomer which has a polymerization degree of less than 10 and is short is used, a difference in the aggregation energy with respect to an acrylic acid oligomer having a different aggregation degree is small, and therefore, a constricted channel structure having a different aggregation degree can be intermingled. Since such constricted channel structures having a different aggregation degree are intermingled, the radius of the port of the constricted channel structure and the radius of a constricted portion are different, and therefore, by capturing a small molecule having a different size, the function of inhibiting the diffusion thereof can be controlled.

When an acrylic acid oligomer which has a polymerization degree of more than 10 and is long is used, the change in the aggregation energy with respect to an acrylic acid oligomer having a different polymerization degree is small, and therefore, a stable constricted channel structure can be formed. Since the radius of the port of the constricted channel structure and the radius of a constricted portion are fixed, by capturing one large molecule or a lot of small molecules, the function of inhibiting the diffusion thereof can be controlled.

### Third Embodiment

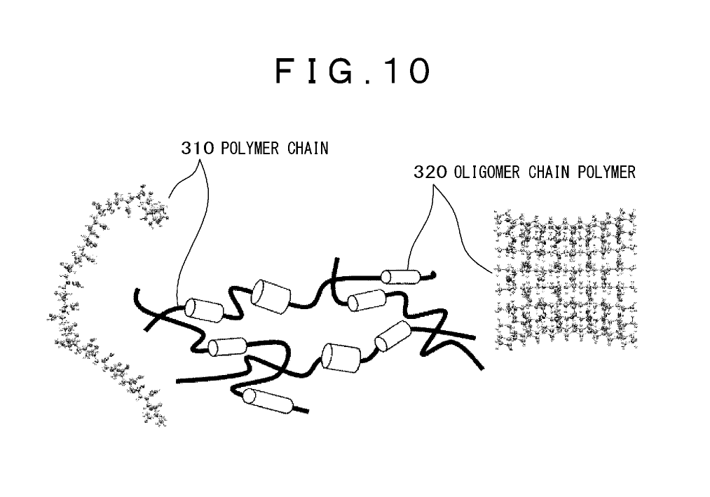

FIG. 10 is a view showing the structure of an acrylic acid binder using a supramolecular polymer structure of acrylic acid of a third embodiment of the invention. As shown in the drawing, the supramolecular polymer structure includes a polymer chain 310 and an oligomer chain polymer 320.

In order to produce a supramolecular polymer structure of acrylic acid, an acrylic acid oligomer having a polymerization degree of n and an acrylic acid polymer having a polymerization degree of about 10,000 are mixed. Part of the structure of the acrylic acid polymer is the structure of an acrylic acid oligomer, and therefore, a polymer is formed in which one acrylic acid oligomer and m−1 number of acrylic acid polymers are aggregated. Therefore, a composite structure is formed in which a constricted channel structure having an aggregation degree of m is added partially to a random structure. Further, a polymer is formed in which two acrylic acid oligomers and m−2 number of acrylic acid polymers are aggregated, and a composite structure can be formed in which a constricted channel structure having an aggregation degree of m is added partially to a random structure. Similarly, a polymer is formed in which m′ number of acrylic acid oligomers and m-m′ number of acrylic acid polymers are aggregated, and a composite structure can be formed in which a constricted channel structure having an aggregation degree of m is added partially to a random structure. Here, m′=1, 2, . . . , or m−1.

The polymer in which m′ number of acrylic acid oligomers and m-m′ number of acrylic acid polymers are aggregated can have both functions constituted by an action of capturing an EC molecule and inhibiting the diffusion thereof derived from the constricted channel structure having an aggregation degree of m and a bonding action derived from the random structure of the acrylic acid polymer having a polymerization degree of about 10,000.

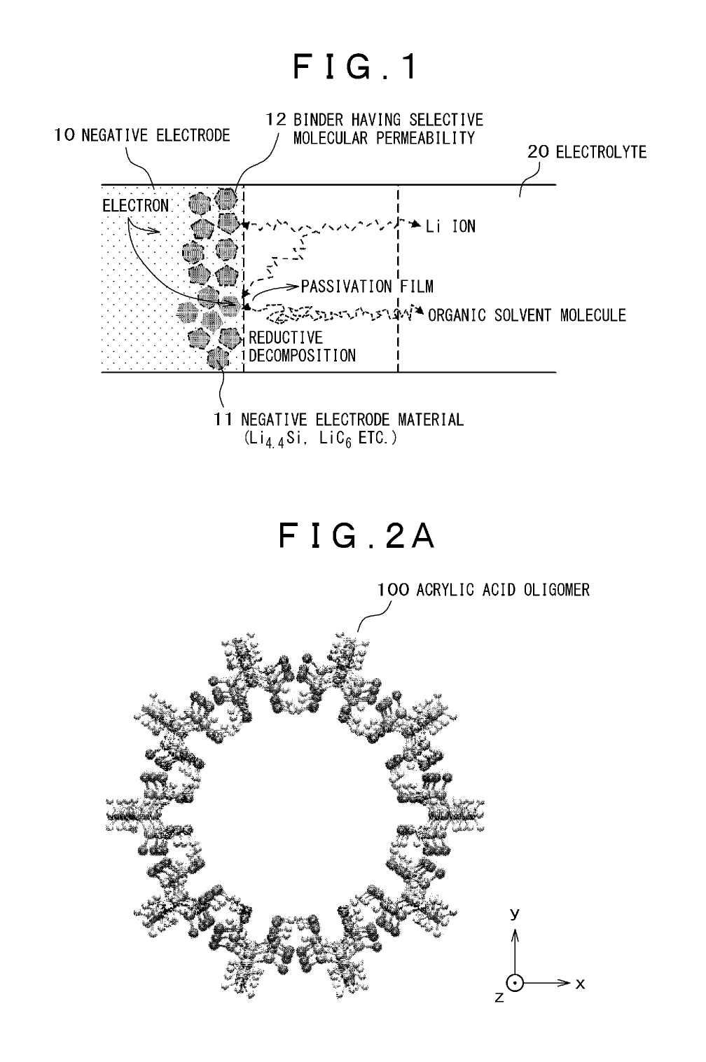

FIG. 1 shows an interfacial region between a negative electrode 10 and an electrolyte 20 in a Li-ion battery of the invention. The negative electrode 10 is formed by bonding a negative electrode material 11 with a binder. By using the supramolecular polymer structure of acrylic acid of the third embodiment as the binder, a binder 12 having selective molecular permeability can be formed around the negative electrode material. Since the constricted channel structure of the binder 12 having selective molecular permeability captures an organic solvent molecule to inhibit the diffusion thereof, the service life of the Li-ion battery can be improved.

Further, in the first embodiment, the second embodiment, and the third embodiment, as the acrylic acid monomer structure, a minimum energy dimer structure is used, and as the single chain structure dependent on the temperature, an arcate structure, a bent structure, a curved structure, or a cyclic structure is used. Further, it is apparent that the constricted channel structure formed by aggregating an acrylic acid oligomer not only has a function of capturing an organic solvent molecule of a Li-ion battery and inhibiting the diffusion of the organic solvent molecule, but also has a function as a carrier such that the supermolecule having captured a drug molecule diffuses in the body as a drug delivery system in a next-generation medical therapy.

The invention made by the present inventor has been specifically described based on the embodiments thereof, however, it goes without saying that the invention is not limited to the above-mentioned embodiments, and can be changed variously without departing from the gist thereof.

### REFERENCE SINGS LIST

10 negative electrode
11 negative electrode material (Li_{4.4}Si, LiC₆, etc.)
12 binder having selective molecular permeability
20 electrolyte
100 acrylic acid oligomer
101 carbon atom
102 oxygen atom
103 hydrogen atom
200 EC (ethylene carbonate) molecule
310 polymer chain
320 oligomer chain polymer

1. A supramolecular structure of acrylic acid, which is a polymer formed by aggregating m number (an aggregation degree of m) of single chains each including n number (a polymerization degree of n) of acrylic acid monomers connected to each other, and has a constricted channel structure, in which the single chains are arranged in a circle on the xy plane, a main chain is oriented along the direction of a central axis in the z direction, and a carboxyl group in a side chain is oriented along a direction perpendicular to the central axis in the z direction.

2. The supramolecular structure of acrylic acid according to claim 1, wherein the supramolecular structure has the single chain in which an acrylic acid monomer structure and a mirror symmetric structure thereof are alternately repeated.

3. The supramolecular structure of acrylic acid according to claim 1, wherein the supramolecular structure is a polymer formed by aggregating an oligomer having a polymerization degree of about 10, which is sufficiently low for facilitating the diffusion of the single chain, and is sufficiently high for decreasing the aggregation energy so as to form a stable polymer structure.

4. The supramolecular structure of acrylic acid according to claim 1, wherein a polymer having a different aggregation degree is intermingled by decreasing the difference in the aggregation energy with respect to an oligomer having a different aggregation degree using an oligomer which has a polymerization degree of less than 10 and is short.

5. The supramolecular structure of acrylic acid according to claim 1, wherein a stable polymer structure is formed by decreasing the change in the aggregation energy with respect to an oligomer having a different polymerization degree using an oligomer which has a polymerization degree of more than 10 and is long.

6. The supramolecular structure of acrylic acid according to claim 1, wherein the radius of a port of the constricted channel structure and/or the radius of a constricted portion are/is changed using a different polymerization degree or a different aggregation degree.

7. The supramolecular structure of acrylic acid according to claim 1, wherein the supramolecular structure has a function of inhibiting the diffusion of a small molecule by capturing the small molecule inside the constricted channel structure by an interaction between the constricted channel structure and the small molecule.

8. The supramolecular structure of acrylic acid according to claim 4, wherein the supramolecular structure has a function of controlling the diffusion of a small molecule by changing the energy of the interaction between the constricted channel structure and the small molecule using the constricted channel structure in which a polymer having a different polymerization degree or a different aggregation degree is intermingled, thereby adjusting the action of capturing the small molecule.

9. The supramolecular structure of acrylic acid according to claim 4, wherein the supramolecular structure has a function of controlling the diffusion of a small molecule by aggregating an oligomer which has a polymerization degree of less than 10 and is short so as to form the constricted channel structure in which a polymer having a different aggregation degree is intermingled, and changing the energy of the interaction between the constricted channel structure and the small molecule, thereby adjusting the action of capturing the small molecule.

10. The supramolecular structure of acrylic acid according to claim 5, wherein the supramolecular structure has a function of controlling the diffusion of a small molecule by aggregating an oligomer which has a polymerization degree of more than 10 and is long so as to form the stable constricted channel structure, and fixing the energy of the interaction between the constricted channel structure and the small molecule, thereby limiting the action of capturing the small molecule.

11. The supramolecular structure of acrylic acid according to claim 4, wherein the supramolecular structure has a function of controlling the diffusion of a small molecule by changing the radius of the port of the constricted channel structure and the radius of a constricted portion using the constricted channel structure in which a polymer having a different polymerization degree or a different aggregation degree is intermingled, thereby adjusting the action of capturing the small molecule.

12. The supramolecular structure of acrylic acid according to claim 4, wherein the supramolecular structure has a function of capturing a small molecule having a different size and inhibiting the diffusion thereof by aggregating an oligomer which has a polymerization degree of less than 10 and is short so as to form the constricted channel structure in which a polymer having a different aggregation degree is intermingled, thereby making the radius of a port of the constricted channel structure and the radius of a constricted portion different.

13. The supramolecular structure of acrylic acid according to claim 5, wherein the supramolecular structure has a function of capturing one large molecule or a lot of small molecules and inhibiting the diffusion thereof by aggregating an oligomer which has a polymerization degree of more than 10 and is long so as to form the stable constricted channel structure, thereby fixing the radius of a port of the constricted channel structure and the radius of a constricted portion.

14. The supramolecular structure of acrylic acid according to claim 4, wherein the constricted channel structure has a self-repair function using a short oligomer such that the oligomer is easy to diffuse, and therefore, when the constricted channel structure is collapsed, the diffusing short oligomer is re-aggregated.

15. The supramolecular structure of acrylic acid according to claim 1, wherein the supramolecular structure includes a composite structure in which the constricted channel structure having an aggregation degree of m is partially formed in a random acrylic acid polymer structure by mixing an acrylic acid oligomer having a polymerization degree of n and an acrylic acid polymer having a polymerization degree of about 10,000, thereby forming a polymer in which m′ number of acrylic acid oligomers and m-m′ number of acrylic acid polymers are aggregated.

16. The supramolecular structure of acrylic acid according to claim 15, wherein the supramolecular structure includes the composite structure in which the acrylic acid oligomer having a polymerization degree of n and the acrylic acid polymer having a polymerization degree of about 10,000 are mixed, and has a function of capturing a small molecule and inhibiting the diffusion thereof derived from the constricted channel structure having an aggregation degree of m and a function of imparting high adhesiveness derived from the acrylic acid polymer structure having a polymerization degree of about 10,000.

17. The supramolecular structure of acrylic acid according to claim 2, wherein the supramolecular structure includes a minimum energy dimer structure as the acrylic acid monomer structure, and the single chain has an arcate structure, a bent structure, a curved structure, or a cyclic structure.

18. A Li-ion battery in which the supramolecular polymer structure of acrylic acid according to claim 15 is used as a binder for a negative electrode.

19. The supramolecular structure of acrylic acid according to claim 5, wherein the supramolecular structure has a function of controlling the diffusion of a small molecule by changing the energy of the interaction between the constricted channel structure and the small molecule using the constricted channel structure in which a polymer having a different polymerization degree or a different aggregation degree is intermingled, thereby adjusting the action of capturing the small molecule.

20. The supramolecular structure of acrylic acid according to claim 5, wherein the supramolecular structure has a function of controlling the diffusion of a small molecule by changing the radius of the port of the constricted channel structure and the radius of a constricted portion using the constricted channel structure in which a polymer having a different polymerization degree or a different aggregation degree is intermingled, thereby adjusting the action of capturing the small molecule.
